(19) United States
(12) Patent Application Publication
(10) Pub. No.: US 2021/0099207 A1
(43) Pub. Date: Apr. 1, 2021

(54) Method and Apparatus for Signal Detection in Wireless Communication System

(71) Applicant: Nokia Technologies Oy, Espoo (FI)

(72) Inventors: Weiqiang MAO, Zhejiang (CN); Jakob HOYDIS, Paris (FR); Yong CHEN, Zhejiang (CN)

(21) Appl. No.: 17/046,332

(22) PCT Filed: Apr. 11, 2018
(86) PCT No.: PCT/CN2018/082713

§ 371 Date: Oct. 9, 2020

(51) Int. Cl. H04B 7/0456; H04B 7/08; H04L 25/06; H04L 25/02; H04L 1/00

(52) U.S. Cl. CPC H04B 7/0456; H04B 7/0854; H04L 2025/03426; H04L 25/0204; H04L 1/0054; H04L 25/067

(57) ABSTRACT

Embodiments of the present disclosure relate to methods, apparatuses and computer program products for signal detection in a wireless communication system. A method implemented at a receiver device includes obtaining a set of received signals; determining a channel matrix via which the set of received signals have been transported; and detecting the set of received signals in a staged manner, wherein in a stage, the method includes detecting the set of received signals, based on the channel matrix and a detection algorithm for the stage; fixing one or more of detected symbols output from the detecting algorithm for the stage; and updating the channel matrix and the set of received signals for usage by a next stage, based on the one or more of the detected symbols that are fixed in the stage.

### FIELD

Non-limiting and example embodiments of the present disclosure generally relate to a technical field of wireless communication, and specifically to methods, apparatuses and computer program products for signal detection in a wireless communication system.

### BACKGROUND

This section introduces aspects that may facilitate better understanding of the disclosure. Accordingly, the statements of this section are to be read in this light and are not to be understood as admissions about what is in the prior art or what is not in the prior art.

In wireless communication systems, there is always a requirement for high spectrum efficiency (SE) and capacity. Multiple input multiple output (MIMO) techniques have been known as an effective way for improving SE and capacity in modern wireless communication systems. For example, MIMO has been adopted as a key feature in Long Term Evolution (LTE)/LTE-Advanced (LTE-A) system developed by the third generation project partnership (3GPP). To further enhance SE and throughput, a concept of massive MIMO (mMIMO) has been proposed.

mMIMO means that a large antenna array is deployed in a wireless communication system. mMIMO has been considered as a key technology in, for example, the coming fifth generation (5G) system. The number of antennas at a 5G node B (also referred to as a gNodeB) may be more than 128. The large number of antennas promises substantial performance gains, but at the same time brings a challenge in signal detection.

### SUMMARY

Various embodiments of the present disclosure mainly aim at providing methods, apparatuses and computer program products for signal detection in a wireless communication system.

In a first aspect of the disclosure, there is provided a method implemented at a receiver device. The method comprises obtaining a set of received signals; determining a channel on which the set of received signals are transported; and detecting a set of transmitted signals from the set of received signals in an iterative manner based on the determined channel, a modulation mode for the set of transmitted signals, and the set of received signals, by using a gradient descent (GD) algorithm.

In an embodiment of the present disclosure, detecting the set of transmitted signals in an iterative manner comprises: in each iteration round, for each of the set of received signals: determining a gradient direction for updating a detected value for each of the set of transmitted signals, based on an detection error caused by the detected value and an associated channel element in the determined channel; determining a learning rate for updating a detected value for each of the set of transmitted signals; and updating the detected value for each of the set of transmitted signals by adding a product of the determined learning rate and the determined gradient direction to the detected value.

In a further embodiment, the gradient direction may be determined as: (yᵢ−Σₖ hᵢₖ*xₖ)h*ᵢⱼ, where yᵢ represents a signal received from the ith receiving antenna, xₖ represents a signal transmitted from the kth transmitting antenna, Σ represents a sum function, hᵢₖ represents a channel element from the kth transmitting antenna to the ith receiving antenna, hᵢⱼ represents a channel element from the jth transmitting antenna to the ith receiving antenna, and h*ᵢⱼ represents a conjugate of hᵢⱼ, i=1, Nr, j and k=1, . . . Nt, and Nr and Nt represent the number of receiving antennas and transmitting antennas respectively.

In another embodiment, determining the learning rate may comprise: determining the learning rate based on a product of an initial learning rate and an increasing factor, the initial learning rate and the increasing factor each being less than 1; or determining the learning rate based on a look-up table and at least one of: quality of the channel, the number of the transmitting antennas, and the number of the receiving antennas.

In some embodiments, determining the learning rate may further comprise: normalizing the learning rate by multiplying with

$$\frac{H R o w L e n S q u a r {e}_{i}}{maxlenSqua r e} or \frac{1}{max len Square} ,$$

where HRowLenSquareᵢ represents a sum of squares of all channel elements in the ith row of the channel, and maxlenSquare represents a maximum value of HRowLenSquareᵢ, where i=1, Nr and Nr is the number of receiving antennas.

In an embodiment, detecting the set of transmitted signals in an iterative manner may comprise: in each iteration, if difference between a detected value of one of the set of transmitted signals and a modulation symbol associated with the modulation mode is less than a proximity threshold, setting the detected value of the one of the set of transmitted signals to the modulation symbol.

In another embodiment, the proximity threshold may depend on the modulation mode.

In some embodiments, detecting the set of transmitted signals in an iterative manner may comprise: determining a set of modulation symbols associated with the modulation mode; determining a maximum real part of the set of modulation symbols; determining a maximum imaginary part of the set of modulation symbols; and in each iteration: if a real part of a detected value for one of the set of transmitted signals exceeds the determined maximum real part, setting the real part to the determined maximum real part; and if an imaginary part of a detected value for one of the set of transmitted signals exceeds the determined maximum imaginary part, setting the imaginary part to the determined maximum imaginary part.

In another embodiment, detecting the set of transmitted signals in an iterative manner may comprise: ceasing the detection in response to: a predetermined number of iteration being met; or difference between detected values for the set of transmitted signals obtained in current iteration round and last iteration round being less than a convergence threshold.

In a second aspect of the disclosure, there is provided a receiver device. The receiver device comprises a processing circuitry and a memory, said memory containing instructions executable by said processing circuitry whereby said receiver device is operative to carry out a method according to the first aspect of the present disclosure.

In a third aspect of the disclosure, there is provided a computer program. The computer program comprises instructions which, when executed by at least one processing circuitry of a device, causes the device to carry out a method according to the first aspect of the present disclosure.

In a fourth aspect of the disclosure, there is provided a computer readable medium with computer program stored thereon which, when executed by at least one processor of a device, causes the device to carry out the method according to the first aspect of the present disclosure.

In a fifth aspect of the present disclosure, there is provided a method. The method comprises: obtaining a set of received signals; determining a channel matrix via which the set of received signals have been transported; and detecting the set of received signals in a staged manner, wherein in a stage, the method comprises: detecting the set of received signals, based on the channel matrix and a detection algorithm for the stage; fixing one or more of detected symbols output from the detecting algorithm for the stage; and updating the channel matrix and the set of received signals for usage by a next stage, based on the one or more of the detected symbols that are fixed in the stage.

In a sixth aspect of the present disclosure, there is provided a receiver device. The device comprises at least one processor and at least one memory including computer program code. The at least one memory and the computer program code are configured to, with the at least one processor, cause the receiver device at least to perform a method according to the fifth aspect of the present disclosure.

In a seventh aspect of the disclosure, there is provided a computer program. The computer program comprises instructions which, when executed by an apparatus, causes the apparatus to carry out the method according to the fifth aspect of the present disclosure.

In an eighth aspect of the disclosure, there is provided a computer readable medium with a computer program stored thereon which, when executed by an apparatus, causes the apparatus to carry out the method of the sixth aspect of the present disclosure.

In a ninth aspect of the present disclosure, there is provided a receiver device. The receiver device comprises: means for obtaining a set of received signals; means for determining a channel matrix via which the set of received signals have been transported; and means for detecting the set of received signals in a staged manner, wherein in a stage, the means for detecting is configured to: detect the set of received signals, based on the channel matrix and a detection algorithm for the stage; fix one or more of detected symbols output from the detecting algorithm for the stage; and update the channel matrix and the set of received signals for usage by a next stage, based on the one or more of the detected symbols that are fixed in the stage.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 illustrates an example wireless communication network in which embodiments of the present disclosure may be implemented;

FIG. 2 shows a model of a two layer artificial neuron network (ANN);

FIG. 3 shows a flowchart of a method at a receiver device for signal detection in a wireless communication system according to an embodiment of the present disclosure;

FIG. 4 shows performance comparison of signal detection method according to an embodiment of the present disclosure and a conventional method;

FIG. 5 illustrates a simplified block diagram of an apparatus that may be embodied as/in a network device or a terminal device.

FIG. 6 shows a flowchart of a method in a receiver device for staged signal detection according to an embodiment of the present disclosure;

FIG. 7 shows example operations to be performed in a stage during staged signal detection according to an embodiment of the present disclosure;

FIG. 8 shows example operations fixing one or more symbols in one stage during staged signal detection according to an embodiment of the present disclosure;

FIG. 9 shows a flowchart of another method in a receiver device for staged signal detection according to an embodiment of the present disclosure;

FIGS. 10-15 show simulation results for staged signal detection solutions according to embodiments of the present disclosure; and

FIG. 16 illustrates a simplified block diagram of another apparatus that may be embodied as/in a network device or a terminal device.

### DETAILED DESCRIPTION

Hereinafter, the principle and spirit of the present disclosure will be described with reference to illustrative embodiments. It should be understood that all these embodiments are given merely for one skilled in the art to better understand and further practice the present disclosure, but not for limiting the scope of the present disclosure. For example, features illustrated or described as part of one embodiment may be used with another embodiment to yield still a further embodiment. In the interest of clarity, not all features of an actual implementation are described in this specification.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The teen circuitry also covers, for example and if applicable to the particular claim element, a baseband integrated circuit or processor integrated circuit for a mobile device or a similar integrated circuit in server, a cellular network device, or other computing or network device.

As used herein, the term “wireless communication network” refers to a network following any suitable wireless communication standards, such as New Radio (NR), Long Term Evolution (LTE), LTE-Advanced (LTE-A), Wideband Code Division Multiple Access (WCDMA), High-Speed Packet Access (HSPA), and so on. The “wireless communication network” may also be referred to as a “wireless communication system.” Furthermore, communications between network devices, between a network device and a terminal device, or between terminal devices in the wireless communication network may be performed according to any suitable communication protocol, including, but not limited to, Global System for Mobile Communications (GSM), Universal Mobile Telecommunications System (UMTS), Long Term Evolution (LTE), New Radio (NR), wireless local area network (WLAN) standards, such as the IEEE 802.11 standards, and/or any other appropriate wireless communication standard either currently known or to be developed in the future.

As used herein, the term “network device” refers to a node in a wireless communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communications. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “communication device”, “terminal”, “user equipment” and “UE” may be used interchangeably.

As yet another example, in an Internet of Things (TOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink (DL) transmission refers to a transmission from a network device to UE, and an uplink (UL) transmission refers to a transmission in an opposite direction. That is, in DL, the network device is a transmitter and the UE is a receiver device; while in UL, the UE is a transmitter and the network device is a receiver device.

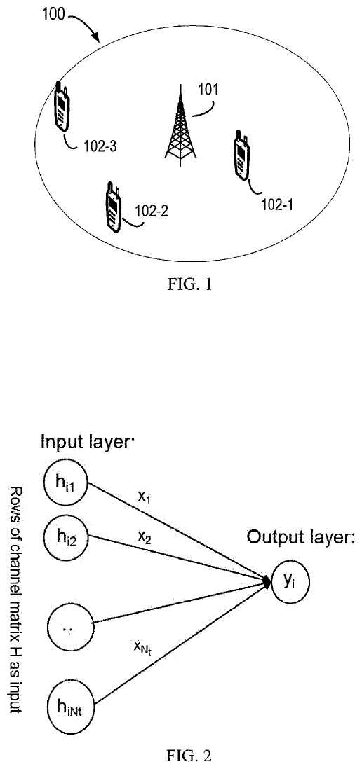

FIG. 1 illustrates an example wireless communication network 100 in which embodiments of the present disclosure may be implemented. As shown, the wireless communication network 100 may include one or more network devices, for example, network device 101. The network device 101 may be in a form of a base station (BS), a Node B (NB), an evolved NB (eNB), a gNB, a virtual BS, a Base Transceiver Station (BTS), or a Base Station Subsystem (BSS), AP and the like.

In this example, network device 101 provides radio connectivity to a set of UEs 102-1, 102-2, and 102-3, which is collectively referred to as “UE(s) 102”, within its coverage. It should be appreciated that in some embodiments, the network device may provide service to less or more UEs and the number of UEs in this shown example does not suggest any limitations as to the scope of the present disclosure.

In some embodiments, a network device, e.g., the network device 101 in FIG. 1, may serve UEs, e.g., UE 102 in FIG. 1, within its coverage with a plurality of antennas. For example, the network device 101 may be equipped with a plurality of transmitting antennas, and/or a plurality of receiving antennas. Likewise, in some embodiments, some or all of the UEs 102 may be equipped with a plurality of antennas for transmitting and/or receiving. In addition, a plurality of UEs 102 may be scheduled to transmit or receive in a same or overlapped time-frequency resource, thereby forming a multi-user MIMO (MU-MIMO) scheme. Therefore, in some scenarios, a receiver device (which may be a network device or a UE) may be required to detect signals transmitted from a plurality of antennas.

MIMO detection algorithms have been proposed, for example, in a book titled “Large MIMO systems” by A. Chockalingam and B. Sundar Rajan, and a book titled “Introduction to MIMO communications” by Jerry R. Hampton, both of which provide a detailed introduction about signal detection algorithms, such as zero forcing (ZF), ZF with interference cancellation (ZF-IC), Linear Minimum Mean Square Error (LMMSE), LMMSE with interference cancellation (LMMSE-IC), and the like. In addition, other signal detection algorithms like sphere decoding, probabilistic data association (PDA), approximate message passing (AMP), deep neuron network (DNN) based MIMO detection algorithm, MIMO detection based on Markov Chain Monte Carlo (MCMC) technology, etc. have been proposed recently. For example, a detailed introduction about the AMP algorithm for MIMO detection may be found, for example, through the link of http://ieeexplore.ieee.org/document/7282651/, while analysis of complexity for the AMP algorithm may be found in https://emtiyaz.github.io/Writings/approxMP0.pdf. It is stated that AMP is an iteration based method with a complexity of about O(max(mn\hat{ }2,m\hat{ }2n)*iteration), where m and n denote the number of transmitting and receiving antennas respectively. A semi-definite relaxation (SDR) algorithm which can be used for MIMO detection is introduced in a paper titled “Semidefinite relaxation of quadratic optimization problems” published at pages 20-34 of IEEE SIGNAL PROCESSING MAGAZINE May 2010, by Zhi-Quan Luo et. al., and according to which, the complexity of the SDR algorithm is at least O(n\hat{ }3.5 log(1/ε)), where ε represents solution precision. Details of the DNN based MIMO detection algorithm may be found in https://arxiv.org/abs/1706.01151.

It is not easy to devise a mMIMO detection algorithm that provides high detection accuracy with reasonable complexity, and inventors of the present disclosure have observed that all existing MIMO detection algorithms have a disadvantage of high computation complexity or functional limitation. For example, some of the algorithms above, like linear detection algorithms ZF and Minimum Mean Square Error (MMSE), etc., have low computing complexity but only achieve low accuracy. Some of the algorithms, like AMP and SDR etc., may achieve high accuracy but at a cost of high computing complexity. Some detection algorithms require calculation of a covariance matrix of a MIMO channel matrix H, and/or an inverse of the channel matrix H. Furthermore, in most detection algorithms, computation complexity increases with the number of the receiving and transmitting antennas in an un-linear manner. This is undesirable, especially for a mMIMO system with a large number of antennas.

In addition, some signal detection algorithm does not work for high order quadrature amplitude modulation (QAM) cases. For example, though the DNN based MIMO detection algorithm achieves comparable performance to that of the AMP/SDR with significantly reduced computing complexity, it requires significant training resources and a Binary Phase Shift Keying (BPSK) modulation scheme for all of the transmitters. It is unclear currently whether it could be extended to higher order modulation schemes and how to support a possibly different modulation scheme for each transmitter.

To solve at least a part of the above problems, methods, apparatuses and computer program products have been proposed in the present disclosure.

In general, in a MIMO or mMIMO system with Nt transmitting antennas and Nr receiving antennas, a received signal may be expressed as Equation (1):

y=Hx+z (1)

where y represents a complex vector with size Nr and represents the received signal (also referred to as a receiving signal) from Nr receiving antennas; H is a complex matrix with size Nr by Nt (i.e., Nr rows and Nt columns) and stands for a channel on which the signal y is transported, i.e., a channel passed/experienced by the signal y. H may be obtained via, for example, channel estimation. x is complex vector with size Nt and represents a transmitted signal from Nt transmitting antennas; z is a complex vector with size Nr and represents received noise on Nr receiving antennas.

The term x in equation (1) is the transmitted signal to be detected from the received signal y at the receiver device side, and in some embodiments of the present disclosure, this signal detection problem may be solved by using y, H and modulation information of x (e.g., a modulation scheme such as BPSK, QPSK, 16QAM, etc., for x) as inputs.

Generally speaking, according to some embodiments of the present disclosure, signal detection may be implemented based on a model of a simple two layer artificial neuron network (ANN) shown in FIG. 2. In particular, as shown in FIG. 2, with this ANN model, each row vector (hᵢ₁, hᵢ₂, . . . h_{iNt}) of the channel matrix H is considered as an input vector, the received value yᵢ associated with a corresponding row of H is considered as an output, while vector x=[x₁, x₂, . . . x_{Nt}] is modelled as weights to be learned.

With this model, an activation function in the output layer may be represented as f(x)=x, and there are Nr data samples in total. In a wireless communication system (e.g., 5G) with mMIMO, the number of receiving antennas at a receiver device (e.g., a gNodeB) may be more than 128, and therefore, the number of data samples is enough to learn the weights x which is the transmitted symbols to be detected.

In some embodiments, a Gradient descent (GD) algorithm, which is conventionally used in machine learning and other related areas, is proposed to be used for solving the signal detection problem.

As an example rather than limitation, a loss function expressed with equation (2) may be used in the GD algorithm.

E(x)=½Σᵢ|yᵢ−Σₖhᵢₖ*xₖ|² (2)

where | | represents modulus of a complex value. The loss function in this example is a sum of error squares, and is a convex function, which guarantees that the GD algorithm will converge to an optimal solution.

By using the GD algorithm for detecting the transmitted signal x, computation complexity required is only O(Nr*Nt). Moreover, better symbol error rate (SER) can be achieved compared with legacy MMSE MIMO detection algorithms. Further, since GD algorithm is based on a simple ANN model, developed ANN technologies (for example, hardware parallel processing) can be used directly. Additionally, embodiments of the present disclosure may provide a framework for building more complex multi-layer type ANN mMIMO detection schemes. In particular, due to unfolding property of each GD iteration, it enables to provide a flexible mMIMO detection solution. That is, it is easy to add new functions into each iteration operation as needed, to obtain more complex and advanced detection solutions.

FIG. 3 shows a flowchart of a method 300 implemented at a receiver device for signal detection in a wireless communication system. The receiver device may be, for example, the network device 101 or UE 102 shown in FIG. 1. For ease of discussion, the method 300 will be described below with reference to network device 101 and the communication network 100 illustrated in FIG. 1. However, embodiments of the present disclosure are not limited thereto.

At block 310, the network device 101 obtains a set of received signals. For example, the set of received signals may be received from Nr receiving antennas, and may be denoted as a vector y with a size Nr. Note that the set of received signals may be received from one or more UEs, for example, one or more UEs 102 in FIG. 1.

At block 320, the network device 101 determines a channel on which the set of received signals are transported, or in other words, a channel passed/experienced by the set of received signals. In a scenario of MIMO communication, the channel may be represented by and called a channel matrix H. It is to be understood that embodiments are not limited to any specific way for obtaining the channel matrix H. Just for illustration purpose, the channel matrix H may be known in advance or obtained via channel estimation. Any blind channel estimation algorithm or channel estimation algorithm based on pilots, reference signals, or training sequences may be used for this purpose. For ease of discussion, assuming there are Nt transmitting antennas and Nr receiving antennas, then the determined channel matrix H has a size of Nr by Nt, i.e., it has Nr rows and Nt columns.

At block 330, the network device 101 detects a set of transmitted signals x from the set of received signals y in an iterative manner, based on the determined channel H, a modulation mode for the set of transmitted signals x, and the set of received signals y, by using the GD algorithm.

In general, GD algorithms include batch gradient descent (BGD) algorithms and stochastic gradient descent (SGD) algorithms. With BGD, all data samples or a subset of the data samples are processed in a batch, then errors caused by detection are summed and used for updating the detection of the set of transmitted signals x. Since x may be modelled as weights in an ANN model as shown in FIG. 2, the signal detection of x is also referred to as weight updating herein. With SGD, GD weights updating is performed for each sample data directly.

SGD or BGD can be used at block 330. In some embodiments, SGD may be used, so as to obtain channel space diversity gains, and/or, to make the detection converge quickly. However, it should be appreciated that embodiments are not limited to BGD or SGD algorithms.

In some embodiments, at block 330, in each iteration round, the network device 101 may update the detection for the set of transmitted signals x. For example, in each iteration round, for each of the set of received signals (yⱼ, corresponding to the jth row of the channel matrix H), the network device 101 determines a gradient direction d for updating a detected value for each of the set of transmitted signals xᵢ. The gradient direction d may be determined based on a detection error caused by the detected value and an associated channel element hᵢⱼ in the determined channel matrix H. Additionally, the network device 100 determines a learning rate R for updating a detected value for each of the set of transmitted signals, and updates the detected value for each of the set of transmitted signals by adding a product of the determined learning rate R and the determined gradient direction d to the detected value. That is, the network device 101 updates the detection for the transmitted signal x as:

x=x+d*R (3).

That is, in each iteration round, the network device 101 updates the detection for each of the transmitted signals x, based on each row of the channel matrix H, respectively, and then proceeds to next iteration round. In the context of the present disclosure, each iteration round is also called an epoch, and each updating based on one row of the channel matrix is also called an iteration.

For instance, the network device 101 may determine the jth element dⱼ of the gradient direction d by equation (4):

dⱼ=(yᵢ−Σₖhᵢₖ*xₖ)h*ᵢⱼ=δᵢ·h*ᵢⱼ (4)

where

δᵢ=yᵢ−Σₖhᵢₖ*xₖ (4a)

δᵢ represents detection error, yᵢ represents a signal received from the ith receiving antenna, xₖ represents a signal transmitted from the kth transmitting antenna, Σ represents a sum function, hᵢₖ represents a channel element from the kth transmitting antenna to the ith receiving antenna, hᵢⱼ represents a channel element from the jth transmitting antenna to the ith receiving antenna, and h*ᵢⱼ represents a conjugate of hᵢⱼ, i=1, Nr, j and k=1, . . . Nt, and Nr and Nt represent the number of receiving antennas and transmitting antennas, respectively.

In an embodiment, the network device 101 may adopt a SGD algorithm at block 330, and use a loss function defined in equation (5):

Eᵢ=½|yᵢ−Σₖhᵢₖ*xₖ|² (5)

where Eᵢ represents a loss value corresponding to the ith row of the channel matrix H. Based on this loss function, the best gradient direction d may be obtained, for example, by calculating the differential of Eᵢ for each xⱼ, as below

$${d}_{j} = - \frac{\partial {E}_{i}}{\partial {x}_{j}} = ( {y}_{i} - {\sum }_{k} {h}_{i k} * {x}_{k} ) {h}_{i j}^{*} \qquad ( 6 )$$

However, it should be appreciated that embodiments are not limited to the specific way for obtaining the gradient direction d.

Alternatively, or in addition, in other embodiments, the network device 101 may determine the learning rate R based on a product of an initial learning rate η and an increasing factor γ, and both the initial learning rate η and the increasing factor γ is less than 1. For example rather than limitation, R may be determined as:

R=η*γ (7).

In a further embodiment, the increasing factor γ may be specific to an iteration round (i.e., epoch), and in this case the increasing factor may be denoted as γ^{ep}. In other words, the increasing factor γ may be different for different iteration rounds. It enables to adjust the step size for updating the detection in each iteration round.

Alternatively, in another embodiment, the network device 101 may determine the learning rate based on a look-up table and at least one of: quality of the channel, the number of the transmitting antennas, and the number of the receiving antennas. For instance, the network device 101 may use a received signal to noise ratio (SNR), Nr, and Nt as inputs to acquire a suitable learning rate R from the lookup table.

In some embodiments, optimized learning rates may be obtained in advance, for example, by machine searching and stored in a loop-up table for later use. For illustration purpose, some learning rate obtained via computer searching for different modulation modes, SNR status and antenna configurations are listed in Table 1 to Table 4.

TABLE 1
Learning rate for 4QAM

SNR

| | 8 | 9 | 10 | 11 | 12 | 13 | 14 |
|---|---|---|---|---|---|---|---|
| | dB | dB | dB | dB | dB | dB | dB |
| Nr = 64 Nt = 16 | 0.3 | 0.4 | 0.4 | 0.6 | 0.7 | 0.7 | 0.7 |
| Nr = 128 Nt = 16 | 0.3 | 0.4 | 0.4 | 0.6 | 0.7 | 0.7 | 0.7 |
| Nr = 64 Nt = 32 | 0.6 | 0.7 | 0.7 | 0.7 | 0.7 | 0.7 | 0.7 |
| Nr 128 Nt = 32 | 0.3 | 0.4 | 0.4 | 0.6 | 0.7 | 0.7 | 0.7 |

TABLE 2
Learning rate for 16QAM

SNR

| | 8 | 9 | 10 | 11 | 12 | 13 | 14 |
|---|---|---|---|---|---|---|---|
| | dB | dB | dB | dB | dB | dB | dB |
| Nr = 64 Nt = 16 | 0.3 | 0.3 | 0.3 | 0.3 | 0.4 | 0.4 | 0.4 |
| Nr = 128 Nt = 16 | 0.2 | 0.2 | 0.2 | 0.2 | 0.2 | 0.2 | 0.4 |
| Nr = 64 Nt = 32 | 0.6 | 0.7 | 0.7 | 0.7 | 0.7 | 0.7 | 0.7 |
| Nr 128 Nt = 32 | 0.3 | 0.3 | 0.3 | 0.3 | 0.3 | 0.3 | 0.3 |

TABLE 3
Learning rate for 64QAM with low SNR

SNR

| | 8 | 9 | 10 | 11 | 12 | 13 | 14 |
|---|---|---|---|---|---|---|---|
| | dB | dB | dB | dB | dB | dB | dB |
| Nr = 64 Nt = 16 | 0.3 | 0.3 | 0.3 | 0.3 | 0.3 | 0.4 | 0.4 |
| Nr = 128 Nt = 16 | 0.2 | 0.2 | 0.2 | 0.2 | 0.2 | 0.2 | 0.2 |
| Nr = 64 Nt = 32 | 0.6 | 0.6 | 0.6 | 0.7 | 0.7 | 0.7 | 0.7 |
| Nr 128 Nt = 32 | 0.3 | 0.3 | 0.3 | 0.3 | 0.3 | 0.4 | 0.4 |

TABLE 4
Learning rate for 64QAM with high SNR

SNR

| | 16 | 20 | 24 | 28 | 32 | 36 | 40 |
|---|---|---|---|---|---|---|---|
| | dB | dB | dB | dB | dB | dB | dB |
| Nr = 64 Nt = 16 | 0.4 | 0.4 | 0.7 | 0.7 | 0.7 | 0.7 | 0.7 |
| Nr = 128 Nt = 16 | 0.2 | 0.4 | 0.7 | 0.7 | 0.7 | 0.7 | 0.7 |
| Nr = 64 Nt = 32 | 0.7 | 0.7 | 0.7 | 0.7 | 0.7 | 0.7 | 0.7 |
| Nr 128 Nt = 32 | 0.4 | 0.4 | 0.7 | 0.7 | 0.7 | 0.7 | 0.7 |

Parameters for computer simulation to search for the above learning rates are listed in Table 5 and Table 6. In addition, during the simulation, γ in equation (7) is set to 1, and each channel element in the channel matrix H is generated according to a normal distribution N(0,1), then normalized by H=H/sqrt(Nt). Noise Z in equation (1) is generated according to a normal distribution N(0,1), then normalized by Z=Z/(10\hat{ }(SNR/10)). The transmitted signals x is normalized by x=x/var(x), where var(x) means the variance of symbol x.

TABLE 5
504 cases for low SNR

| Parameters | Values |
|---|---|
| Learning rate | 0.2~0.7 |
| Number of transmitted symbols Nt | 16; 32 |
| Number of received antenna Nr | 64; 128 |
| QAM | 4QAM; 16QAM; 64QAM |
| SNR | 8 dB~14 dB |
| Number of Epoch | 5 |

TABLE 6
168 cases for high SNR

| Parameters | Values |
|---|---|
| Learning rate | 0.2~0.7 |
| number of transmitted symbols Nt | 16; 32 |
| number of received antenna Nr | 64; 128 |
| QAM | 64QAM |
| SNR | 16 dB; 20 dB; 24 dB; 28 dB; |
| | 32 dB; 36 dB; 40 dB |
| Number of Epoch | 5 |

In some embodiments, it is also possible to use lower learning rate value while setting bigger epoch round for GD updating.

Furthermore, to obtain a better convergence property, in some embodiments, the determined learning rate R may be further normalized by the network device 101. As an example rather than limitation, the network device 101 may normalize the learning rate R by multiplying it with a factor

$$\frac{H R o w L e n S q u a r {e}_{i}}{maxlenSqua r e} or \frac{1}{max len Square} ,$$

where HRowLenSquareᵢ represents a sum of squares of all channel elements in the ith row of the channel matrix i.e., HRowLenSquareᵢ=Σⱼ|hᵢⱼ|². maxlenSquare represents a maximum value of HRowLenSquareᵢ, i.e., maxlenSquare=maxᵢ{HRowLenSquareᵢ}, where i=1, Nr and Nr is the number of receiving antennas.

Accordingly, in some embodiments, detection for the jth transmitted signal xⱼ may be updated using equation (8) or (9):

$$\begin{matrix}{x}_{j} = {x}_{j} + \frac{H R o w L e n S q u a r {e}_{i} * rate * {δ}_{i} * {h}_{i j}^{*}}{max len Square} & ( 8 ) \\ {x}_{j} = {x}_{j} + \frac{rate * {δ}_{i} * {h}_{i j}^{*}}{maxlenSquare} . & ( 9 )\end{matrix}$$

For instance, if maxlenSquare<=1, xⱼ may be update based on (8) or (9), and if maxlenSquare>1, xⱼ may be updated based on (9).

The above factor

$$\frac{H R o w L e n S q u a r {e}_{i}}{maxlenSqua r e} and \frac{1}{max len Square}$$

provide a way to adjust the learning rate by normalization, thereby ensuring the convergence of the iteration.

Alternatively, or in addition, in some embodiments, in order to further improve the convergence property of the detection algorithm, at block 330, if a detected value for one transmitted signal xⱼ is already close enough to one modulation value associated with the modulation mode of the transmitted signal (e.g., 64QAM, or QPSK), the network device 101 may set the detection value for the transmitted signal xⱼ as that modulation value. This helps to achieve quick convergence and avoid learning overfit.

For example, at block 330, in each iteration, if difference between a detected value of one of the set of transmitted signals xⱼ and a modulation symbol (denoted as my) associated with the modulation mode is less than a proximity threshold Tₚᵣₒₓ, the network device 101 may set/anchor the detected value of the one of the set of transmitted signals to the modulation symbol mv. That is:

if |mv−xⱼ|<Tₚᵣₒₓ,then set xⱼ=mv,

where xⱼ represents the ith transmitted signal. Such operation is also referred to as an anchoring operation thereafter.

In some embodiments, the proximity threshold Tₚᵣₒₓ may depend on the modulation mode. For example, the proximity threshold Tₚᵣₒₓ may be different for QPSK and 16QAM modulation modes. For illustration rather than limitation, in some embodiments, the proximity threshold Tₚᵣₒₓ may be determined as:

Tₚᵣₒₓ=anRate*stepValue (10)

where anRate represents an initial anchor rate, which may be set to be, for example but not limited to, 0.1, while the step Value represents an adaptive factor which may depend on the modulation mode for the transmitted signals. For instance, the stepvalue for a modulation mode may be set to the nearest distance between modulation symbols associated with the modulation mode. For QPSK, values of the modulation symbols may be expressed as:

SMV={x+yj} for x,y∈{−1,1} (11)

In this example, the nearest distance between these symbols is 2. As a result, step Value for QPSK may be set to 2. Likewise, for 16QAM, values for the modulation symbols may be expressed as:

SMV={x+yj} for x,y∈{−1,−⅓,⅓,1} (12)

In this case, the nearest distance between these symbols is ⅔, so step Value for 16QAM may be set to ⅔. Alternatively, for 16QAM, values for the modulation symbols may be expressed as:

SMV={x+yj} for x,y∈(−3,−1,1,3) (12′)

In this case, the nearest distance between these symbols is 2, so step Value for 16QAM may also be set to 2.

Alternatively, or in addition, in some embodiments, to achieve quick convergence, at block 330, the network device 101 may put a constraint on the detected value for the transmitted signal x. For example, the network device 101 may determine a set of modulation symbols associated with the modulation mode (for example, using equation (11) or (12) for QPSK and 16QAM respectively). For the set of modulation symbols, the network device 101 determines a maximum real part and a maximum imaginary part. The maximum real part and the maximum imaginary part serve as a limit for the real part and imaginary part of the detected signal respectively. That is, in each iteration, if a real part of a detected value for one of the set of transmitted signals (e.g., the jth transmitted signal xⱼ) exceeds the determined maximum real part, the network device 101 sets the real part to the determined maximum real part. Likewise, if an imaginary part of a detected value for one of the set of transmitted signals exceeds the determined maximum imaginary part, the network device 101 sets the imaginary part to the determined maximum imaginary part.

As an example rather than limitation, computer instructions for an anchor function (denoted as anchor ( )) for implementing the above optional anchoring operations for improving the convergence property may be constructed as the following:

### Initialization:

set anchor rate: anRate. For example, anRate=0.1
calculate the stepvalue for SMV, which is the symbol neighbour's nearest distance. for example: for QPSK, stepvalue=2; For 16QAM, stepvalue=2.
anchor( ) main routine:
for j=0 to Nt:

#real(x) to get real value of complex x; imag(x) to get imag value of complex x.

#real(SMV) is all SMV element's real value composed set.

#imag(SMV) is all SMV element's imag value composed set.

#x value cannot be bigger or less than the biggest or least real or imag value in SMV.

if real(xⱼ)>max(real(SMV)):
real(xⱼ)=max(real(SMV))
if real(xⱼ)<min(real(SMV)):
real(xⱼ)=min(real(SMV))

if imag(xⱼ)>max(imag(SMV)):

imag(xⱼ)=max(imag(SMV))

if imag(xⱼ)<min(imag(SMV)):

imag(xⱼ)=min(imag(SMV))
find the nearest modulation value my for xⱼ: mv=argmin_{mv∈SMV}|mv−xⱼ|
if |mv−xⱼ|<anRate*stepValue, set xⱼ=mv
#end of loop
output the anchored weights
#anchor( ) function ended

The anchoring operation may bring several benefits, such as quick convergence, and ANN overfit avoidance. For instance, if all the weights (i.e., transmitted signals x) can be anchored, the GD based iteration operation can be stopped immediately. In addition, in some embodiments, the anchoring operation also helps to improve mMIMO detection accuracy, e.g., symbol error rate may be reduced, since noise caused by the transmitted signal being anchored is removed.

The detection at block 330 may be terminated in response to various conditions. For example, in some embodiments, the network device 101 may cease the detection at block 330 if a predetermined number of iteration rounds (epoch) has been reached. This way of ending the detection may be referred to as EC1 hereafter.

Alternatively, in some embodiments, the difference between detected values for the set of transmitted signals obtained in current iteration round and last iteration round may be determined. If the different falls below a convergence threshold, the detection may be terminated. For example, the network device may cease the update if a change in the transmitted signal x caused by updating is less than a convergence threshold ∈, i.e.,

|x_{cur}−xₚᵣₑ|²<∈ (13)

where ∈ represents a pre-defined convergent threshold; x_{cur} represents detected value for x in current iteration round, and xₚᵣₑ represents detected value for x in last iteration round. This way for ending the iteration round may be referred to as EC2 hereafter.

In some embodiments, the iteration/updating may be ceased by using a hybrid method of EC1 and EC2. That is, the network device 101 may end the updating if predetermined number of iteration rounds has been finished, or if the change in x is already less than ∈ shown in Equation (12). The hybrid way for stopping the updating may be referred to as EC3.

For illustration purpose and without limitation, computer procedures for implementing GD based signal detection with method EC3 for ending the update may be constructed as below:

### Input:

Channel estimation H, which is Nr*Nt matrix.
Received signal y, which is Nr*1 matrix
Modulation mode of transmitted symbol x, here each symbol x can use different modulation mode.

### Output:

Decoded symbol x, which is Nt*1 matrix

### Initialization:

Set GD end condition: epoch value based; threshold value based; or both epoch value and threshold value based. Set epoch value and ∈ value.
Set initial weights value x=0.
Set learning rate method:
Method 1: based on initial learning rate value η and learning rate epoch level decreasing rate γ, both two value shall be less than 1.
Method 2: based on pre-defined lookup table, the pre-defined table can be built based on the experience or testing.
#anchor( ) function is not mandately, but it's helpful for avoiding overfit
Set anchor rate value: anRate, for example 0.1. this parameter is used in anchor( ) function
#optional initialization part is not mandately, but it's helpful for quick convergent.

### Optional Initialization:

Calculate H matrix's row length square: HRowLenSquare, which is Nr*1 matrix
Calculate maximum H row length square: maxlenSquare=max(HRowLenSquare)
H row order can be adjusted, for example, based on HRowLenSquare descently
GD Based mMIMO Main Routine:
For ep=0 to epoch:
#this step is to set learning rate, two ways are suggested:
Set learning rate for this epoch: rate=η*γ^{ep} or rate is selected based on pre-defined lookup table
#if anchor( ) function is enabled, call it one time in each epoch round:
Call anchor( )
#if anchor( ) find the learned weights are already good enough, quit immediately.
If all weights can be anchored:
quit the epoch loop
#start doing GD updating for each row of H:
For i=0 to Nr:
For i-th H row, calculate the error based on (4a):
For j=0 to Nt:
If optional initialization used:
If maxlenSquare<=1, weights update can be based on (8) or (9); If maxlenSquare>1, weights update can be based on (9);
If optional initialization is not used, do the weights updating based on (3)-(4a);
If all H's rows' GD updating is finished in this epoch round, check the end condition:

If equation (13) is true, GD updating is finished, quit the epoch loop #end of the GD updating loop

#end of the epoch loop
Output the decoded weights:

If output is softbits, just output the learned weights

If output is hardbit, find the nearest symbol value from SMV for each weight as output #GD based mMIMO detection algorithm ended

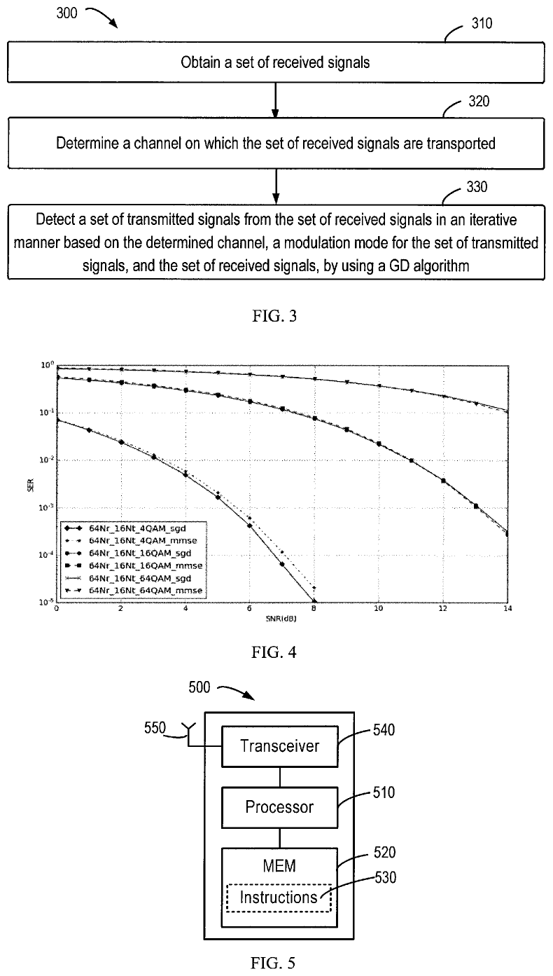

To verify advantage of the proposed detection solution, performance of some embodiments of GD based signal detection methods have been compared with a conventional MMSE method, and results of the comparison are shown in FIG. 4.

During the comparison, end condition EC1 is adopted, and the number of iteration rounds (epoch) is set to 10. In addition, the learning rate R is set to a constant value of 0.3 for all different SNR and all epoch round, and its normalization is based on 1/maxlenSquare. Anchoring operation is used and in which the anRate in equation (10) is set to 0.1. For each SNR case, 30000 data samples are used to obtain the result.

The results show that GD based detection is better than MMSE based detection in 4QAM case in terms of SER performance. In some embodiments, the performance improvement is guaranteed by the loss function which is a convex function and ensures convergence of the GD based updating. Furthermore, the proposed GD based detection solution does not involve any channel matrix transformation (for example, no need for calculating covariance matrix or pseudo inversion of the channel matrix H), and as a result, all channel spatial diversity properties are kept. This feature also contributes the better performance.

As shown in FIG. 4, for 16QAM and 64QAM cases, GD based detection and MMSE based detection achieve almost the same performance. However, GD-based detection requires less computation complexity. In particular, the computation complexity of GD based detection is only O(Nr*Nt). During the detection, iteration can be stopped if anchoring operation finds that weights x are already close enough to expected symbols, therefore average number of iteration round needed is small.

In addition, the proposed detection method is based on the design of ANN, which means that developed ANN technologies can be reused in the detection. For example, it can support parallel processing in ANN supported hardware.

The proposed detection solution is also flexible. It is easy to add more advanced functions into each iteration or iteration round. For example, in some embodiments, anchoring operation and/or normalization operation for the learning rate may be added. This makes it possible for the solution to benefit from further development.

It should also be noted that embodiments of the present disclosure can be applied widely in various scenarios. For example, some embodiments may be used for complex mMIMO signal detection, and support different modulations, different SNRs, and different antenna numbers, etc.

FIG. 5 illustrates a simplified block diagram of an apparatus 500 that may be embodied in/as a network device, for example, the network device 101 shown in FIG. 1, or embodied in/as a terminal device, for example, the terminal device 102 shown in FIG. 1.

As shown by the example of FIG. 5, apparatus 500 comprises a processor 510 which controls operations and functions of apparatus 500. For example, in some embodiments, the processor 510 may implement various operations by means of instructions 530 stored in a memory 520 coupled thereto. The memory 520 may be any suitable type adapted to local technical environment and may be implemented using any suitable data storage technology, such as semiconductor based memory terminal devices, magnetic memory terminal devices and systems, optical memory terminal devices and systems, fixed memory and removable memory, as non-limiting examples. Though only one memory unit is shown in FIG. 5, a plurality of physically different memory units may exist in apparatus 500.

The processor 510 may be any proper type adapted to local technical environment, and may include one or more of general purpose computers, special purpose computers, microprocessors, digital signal processors DSPs and processors based on multicore processor architecture, as non-limiting examples. The apparatus 500 may also comprise a plurality of processors 510.

The processors 510 may also be coupled with a transceiver 540 which enables reception and transmission of information by means of one or more antennae 550 and/or other components. For example, the processor 510 and the memory 520 can operate in cooperation to implement method 300 described with reference to FIG. 3. It shall be appreciated that all the features described above with reference to FIG. 3 also apply to apparatus 500, and therefore will not be detailed here.

Various embodiments of the present disclosure may be implemented by a computer program or a computer program product executable by one or more of the processors (for example processor 510 in FIG. 5), software, firmware, hardware or in a combination thereof.

Although some of the above description is made in the context of a wireless communication system shown in FIG. 1, it should not be construed as limiting the spirit and scope of the present disclosure. The principle and concept of the present disclosure may be more generally applicable to other scenarios.

In another aspect of the present disclosure, a staged signal detection framework and related methods, apparatuses and computer program products are proposed. Compared with conventional solutions, for example a VBLAST algorithm (https://en.wikipedia.org/wiki/Bell_Laboratories_Layered_Space-Time) and a detection algorithm disclosed in a US patent application US20040242179A (http://pdfstore.patentorder.com/pdf/us/179/us2004242179.pdf) which removes matrix inversion operations from the detection algorithm, some embodiments of the present disclosure provide more flexibility to achieve a tradeoff between performance and complexity, and achieves better performance.

In some embodiments, by using the staged signal detection framework which may also be referred to as a staged symbol fix (SSF) framework, a low complexity and low accuracy (m)MIMO detection algorithm may be transformed into a low complexity and high accuracy (m)MIMO detection algorithm. That is, some embodiments improve detection accuracy while keeping computation complexity at a low level.

In some embodiments, the proposed staged signal detection solution provides flexibility to choose any type of detection algorithm/detector for each processing stage independently. Furthermore, embodiments of the present disclosure are not limited to any specific detection algorithm/detector used in each stage. That is, an existing mMIMO detection algorithm may be used in a stage of the SSF framework to improve detection accuracy at a cost of slightly increased complexity. In some embodiments, the only requirement for a mMIMO detection algorithm chosen for a stage is that it provides soft symbols as outputs, i.e., the detection algorithm outputs a probability estimation rather than a hard decision for an individual symbol.

For illustration rather than limitation, a conventional linear ZF detector, a linear MMSE detector, or a GD based mMIMO detection algorithm using a developed ANN technology proposed herein may be used at a stage of the proposed SSF framework.

In some embodiments, the staged signal detection solution allows choosing the total number of stages for the staged signal detection solution flexibly, and the total number of stages may be significantly smaller than the number of transmitting antennas Nt.

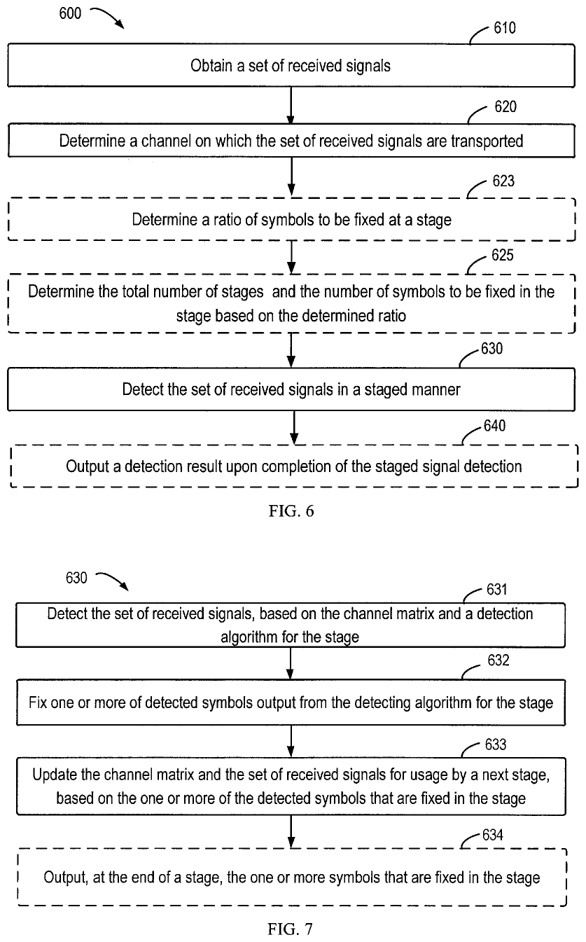

FIG. 6 shows a flowchart of a method 600 implemented at a receiver device for staged signal detection in a wireless communication system according to an embodiment of the present disclosure. The receiver device may be, for example, the network device 101 or terminal device 102 shown in FIG. 1. For ease of discussion, the method 600 will be described below with reference to network device 101 and the communication network 100 illustrated in FIG. 1. However, embodiments of the present disclosure are not limited thereto.

As shown in FIG. 6, at block 610, network device 101 obtains a set of received signals. For example, the set of received signals may be received from Nr receiving antennas, and may be denoted as a vector y with a size Nr. Note that the set of received signals may be received from one or more terminal devices, for example, one or more terminal devices 102 in FIG. 1.

At block 620, network device 101 determines a channel via which the set of received signals are transported, or in other words, a channel passed/experienced by the set of received signals. In a scenario of MIMO communication, the channel may be represented by and called a channel matrix H. It is to be understood that embodiments are not limited to any specific way for obtaining the channel matrix H. Just for illustration purpose, the channel matrix H may be known in advance or obtained via channel estimation. Any blind channel estimation algorithm or channel estimation algorithm based on pilots, reference signals, or training sequences may be used for this purpose. For ease of discussion, assuming there are Nt transmitting antennas and Nr receiving antennas, then the determined channel matrix H has a size of Nr by Nt, i.e., it has Nr rows and Nt columns.

At block 630, network device 101 detects the set of received signals y in a staged manner. The staged signal detection at block 630 comprises one or more processing stages, and the total number of stages may be denoted as Nₜₒₜ herein, where Nₜₒₜ is an integer equal to or larger than 1.

In some embodiments, in a stage of the totally Nₜₒₜ stages, the network device 101 may perform operations shown in FIG. 7 which illustrate an example for operations that may be performed in one processing stage.

In the example shown in FIG. 7, at block 631, the network device 101 detects the set of received signals y, based on the channel matrix H and a detection algorithm for the stage. Note that detecting the set of received signals y means estimating a set of transmitted signals x from the set of received signals y. The staged signal detection method proposed herein allows selecting a detection algorithm for each stage independently. That is to say, same or different detection algorithms may be used in different stages.

For illustration rather than limitation, the detection algorithm for one stage may be, but not limited to, one of: a ZF based algorithm, a MMSE based algorithm and a GD based algorithm (e.g., a SGD based algorithm) proposed in the present disclosure. Details for the ZF or MMSE based detection algorithm may be found, for example, in a book titled “Large MIMO systems” by A. Chockalingam and B. Sundar Rajan, or a book titled “Introduction to MIMO communications” by Jerry R. Hampton.

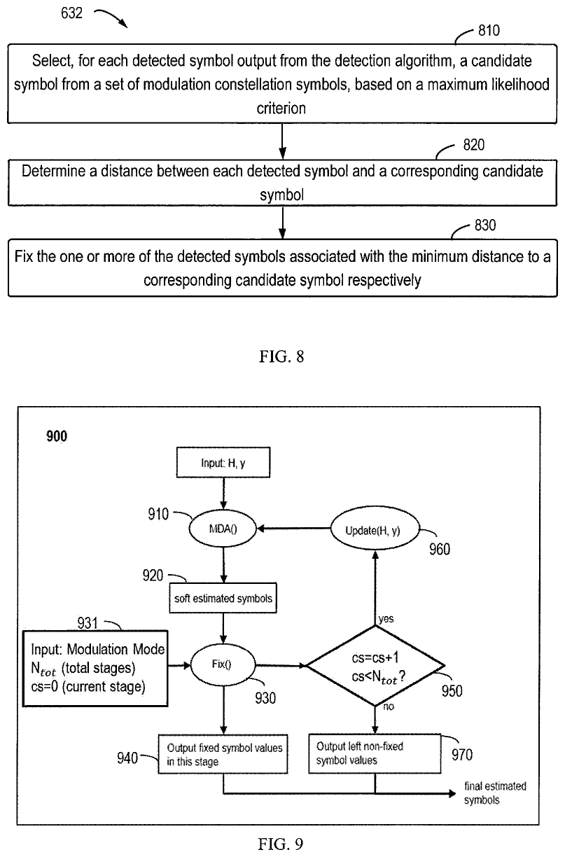

At block 632, the network device 101 fixes one or more of detected symbols output from the detecting algorithm for the stage. In other words, values for the one or more of the detected symbols are fixed/determined. In some embodiments, the network device 101 may fix the one or more detected symbols based on modulation information (e.g., a modulation scheme/mode such as BPSK or QPSK, or 16QAM) of the received signals. An example implementation for the fixing operation performed in block 632 is illustrated in FIG. 8.

As shown in FIG. 8, at block 810, the network device 101 may select, for each detected symbol output from the detection algorithm for the current stage, a candidate symbol from a set of modulation constellation symbols determined by a modulation scheme (e.g., QPSK) for the set of received signals, for example based on a maximum likelihood (ML) criterion. For instance, a set of modulation constellation symbols A_{QPSK} for a QPSK modulation scheme includes 4 constellation symbols A1 to A4, i.e., A_{QPSK}={A1, A2, A3 A4}, and if a detected symbol has a minimum Euclidean distance with the constellation symbol A1, the receiver device 102 may select A1 as the candidate symbol for the detected symbol. Candidate symbols for other detected symbols output from the detection algorithm may be selected likewise.

At block 820, the network device 101 determines a distance between each detected symbol and its corresponding candidate symbol. For example, if there are M detected symbols Sᵢ, i=1, 2, . . . M, output from the detection algorithm at a stage, and a candidate symbol Cᵢ with the minimum distance with a detected symbol Sᵢ is selected for the detected symbol Sᵢ, then at block 820, the network device 101 may determine a distance dᵢ between each Sᵢ and Cᵢ, where i=1, 2, . . . M, and Cᵢ is selected from a set of constellation symbols, for example A_{QPSK}={A1, A2, A3 A4}.

At block 830, the network device 101 fixes one or more detected symbols associated with the minimum distance to a corresponding candidate symbol respectively. As an example, the receiver device may sort the distance dᵢ in an ascending order, and fix the first L detected symbols associated with the first L minimum distance to their corresponding candidate symbols.

It should be appreciated FIG. 8 just provide an example for the fixing operation performed at block 632 of FIG. 7, and the fixing operation is not limited to the exact example shown.

In some embodiments, the fixing operation performed at block 632 of FIG. 7 may be implemented via a function which may be denoted as Fix( ) herein. Note that if the detected symbols output from the detection algorithm are complex values, the Fix( ) function may process each detected symbol with a complex value directly, or process real and imaginary parts of the complex value separately. For the former case, a two dimensional (2D) Euclidean distance may be used for selecting the nearest candidate symbol for a detected symbol, while a one dimensional (1D) Euclidean distance may be used for the latter case.

For illustration rather than limitation, an example for constructing the Fix( ) function is described below, where separate processing of the real and imaginary parts of the detected symbols is assumed, and correspondingly values of real part of constellation symbols are used for calculating a distance between a detected symbol and a candidate symbol.

### Fix ( ) Function Description:

### Input:

ds: a list of detected symbols, each item of which includes an index and a value for a detected symbol. For example, the ith item is represented as (indexᵢ,dv_{index}_{ᵢ}). In the Fix( ) function, these symbols' values will be checked, and values of some symbols will be fixed in a stage.
SMV: a set of values for constellation symbols.

### Output:

fs: a list of fixed symbols and their corresponding values

### Initialization:

(i) Determine a SMV to use. For example,

### For QPSK,

SMV={−1,1} (14)

For 16QAM

SMV={−3,−1,1,3} (15)

(ii) Set a value for fNum which represents the number of symbols to be fixed in a stage. As an example rather than limitation, the value for fNum may be determined/set based on a ratio of symbols to be fixed in a stage. Or, the value for fNum may decrease exponentially with the stage. For instance, the value for fNum may be determined/set as:

fNum=max(1,[len(ds)*fRatio]) (16)

or,

fNum=[len(ds)f=YRatio] (17)

where len(ds) means the total number of detected symbols output from the detection algorithm for a current stage, fRatio represents a ratio of symbols to be fixed in the current stage, which may take a value between 0 and 1, and [.] denotes an operation of getting an integer part of a real number.

### Fix( ) Main Routine:

(i) For each detected symbol, find a candidate symbol which is the nearest modulation constellation symbol value from the SMV For example, for each item (e.g., the ith item (indexᵢ,dv_{index}_{ᵢ})) in ds, find its nearest modulation value by:

mv_{index}_{ᵢ}=argmin_{x∈SMV}|x−dv_{index}_{ᵢ}| (18).

(ii) Build a minimum distance list (denoted as minDis herein), in which the ith item is obtained by:

minDisᵢ=|mv_{index}_{ᵢ}−dv_{index}_{ᵢ}| (19)

(iii) Select detected symbols to be fixed. For instance, order items in inDis in an ascending order, and select detected symbols associated with the first fNum elements in the sorted minDis as symbols to be fixed. Then the detected symbols fixed in a stage may be represented by a list fs, the ith item of which may be represented as:

fsᵢ=(indexᵢ,mv_{index}_{ᵢ}),i=1, . . . FNum (20)

### (iv) Output fs.

### (v) End of Fix( ) Function.

In the example above, the Fix( ) function fixes/determines a value for one or more detected symbols based on a Euclidean distance based criterion, and the number of the one or more detected symbols is determined by fNum which is configurable and may be stage specific. It should be appreciated, however, embodiments are not limited to the specific way described above for fixing the detected symbols. In another embodiment, a different criterion may be used, and/or, the value of fNum may be constant for each stage.

Once a detected symbol is fixed, its detection is finished, and the detected symbol will not participate in later processing stages anymore. In some embodiments of the present disclosure, the detected symbols that are fixed in one stage may be excluded from participating in later processing stages by updating the channel matrix and the set of received signals, as shown in block 633 of FIG. 7.

At block 633, the network device 101 updates the channel matrix H and the set of received signals y for usage by a next stage, based on the one or more of the detected symbols that are fixed in the current stage. With the updating operation, impacts of the fixed symbols may be removed from the channel matrix and the set of received signals. For illustration rather than limitation, at block 633, the network device 101 may update the channel matrix H by removing, from the channel matrix H, one or more columns corresponding to the one or more of the detected symbols that are fixed in the current stage. In addition, the network device 101 may update the set of received signals y by subtracting from y a value contributed by the one or more of the detected symbols that are fixed in the current stage.

In some embodiments, the updating operation may be performed/controlled by a function which may be denoted as update ( ) for simplicity. For illustration purpose only, an example for constructing the update ( ) function is provided below in a form similar to computer instructions:

### Update( ) Function Description:

### Input:

fs: the list offixed symbols output from the fixing operation, for example the Fix( ) function.
H: the channel matrix.
y: a vector of the received signals.

### Output:

H: updated H, by removing columns of corresponding fixed symbols;
y: updated vector y, by subtracting fixed symbols' value;

### Update( ) Main Routine:

#Subtract Fixed Symbols' Value from y:
for i=0 to len(fs):

k=indexᵢ

for j=0 to Nr:

yⱼ=yⱼ−hⱼₖ*mvₖ (21)

### #Remove Corresponding Column in H Matrix:

For each indexᵢ of fs, remove its corresponding column (i.e., the indexᵢ-th column) from H matrix.

### Output H and y.

### End of Update( ) Function.

It should be appreciated that FIG. 7 and FIG. 8 only illustrate example operations that may be performed in a single processing stage. The method 600 shown in FIG. 6 may comprise a plurality of processing stages at block 630. In such a case, each stage may be performed in a way similar to that described with reference to FIGS. 7 and 8.

In some embodiments, the total number of stages Nₜₒₜ involved in block 630 of method 600 may be configurable. As an example rather than limitation, the network device 101 may firstly determine a ratio of symbols to be fixed at a stage (which may be denoted as fRatio herein) at block 623 in FIG. 6, and then determine the total number of stages Nₜₒₜ and the number of symbols (denoted as fNum herein) to be fixed in the stage based on the determined ratio (i.e., fRatio) at block 625 in FIG. 6.

For instance, the total number of stages Nₜₒₜ may be determined based on fRatio by:

Nₜₒₜ=[−log_{(1-fRatio)}·Nₜ]+1 (22)

where Nₜ stands for the number of transmitting antennas. It should be appreciated that embodiments of the present disclosure are not limited to any specific way for determining values for fRatio, fNum, and Nₜₒₜ. In some embodiments, the ratio of symbols to be fixed in a stage may be determined based on a receiving signal to noise ratio (SNR). For example, if the receiving SNR is high, a large number of detected symbols may be fixed in one stage; otherwise, a small number of detected symbols may be fixed in one stage.

Normally, the total number of stages Nₜₒₜ required for the staged signal detection is far less than the number of detected symbols, for example, when fNum is determined based on equation (16) or (17) which results in an exponential decrease in the number of symbols to be fixed in one stage.

The staged signal detection ends when the number of stages reaches the configured total number of stages Nₜₒₜ, or all symbols are fixed. In some embodiments, the network device 101 outputs a detection result upon completion of the staged signal detection at block 640 in FIG. 6. In some embodiments, the detection result may only include symbols which are fixed during the stages of detection, which means that all detected signals have been fixed during the staged detection. In some embodiments, the detection result may include both fixed symbols and un-fixed symbols, which means that only a portion of detected signals have been fixed during the staged detection. The un-fixed symbols may be recovered via following processing, for example channel decoding operation.

Alternatively, in some embodiments, the network device 101 may output, at the end of a stage, the one or more symbols that are fixed in the stage, at block 634 in FIG. 4. In addition, if there is still one or more symbols remain unfixed after completion of the staged signal detection, the network device 101 also outputs the remaining symbol at block 640 in FIG. 6.

For illustration purpose, another example of the staged signal detection operation is shown in FIG. 9. This example may be considered as a specific implementation of blocks 630 and 640 in FIG. 6. The method shown in FIG. 9 may be implemented, for example, by the network 101 or the terminal device 102 in FIG. 1.

In the example of FIG. 9, the staged signal detection is implemented via a function denotes as ssfMDA( ) which comprises several sub-functions including MDA( ) Fix( ) and Update( ). The sub-function MDA( ) is a function for signal detection in a stage of the SSF framework using a selected MIMO detection algorithm. It should be appreciated that the detection algorithm may be selected for each stage independently. Sub-function Fix( ) is for fixing one or more (e.g., fNum) detected symbols output from MDA( ) to corresponding modulated constellation symbol values with the least distance from the one or more detected symbols. The fixed symbols will not participate in later processing stages. For example, the fixed symbols will not be further detected using the MDA( ) function in next stage. Since some example implementations of the Fix( ) function have been described above, details will not be repeated here. The Update( ) function is for updating the channel matrix H and the set of received signals y by removing impacts of the fixed symbols, as already described above.

As shown in FIG. 9, the channel matrix H and the set of received signals x are used as inputs. At block 910, MDA( ) function is performed for signal detection in a stage. The detection outputs soft estimated symbols at block 920, which means that a probability estimation rather than a hard decision for a symbol is output. At block 930, one or more of the detected symbols are fixed via the Fix ( ) function. The Fix ( ) function may use modulation information, e.g., modulation mode as input, as shown in bock 931 of FIG. 9. Symbols fixed at block 930 is output at block 940. At block 950, the index of the stage is increased by 1, and the receiver device checks whether total number of stages is reached. If the total number of stages is not reached, the channel matrix H and the set of received signals y are updated via the Update ( ) function at block 960, and the processing enters the next stage. If the total number of stages is reached, the staged signal detection stops, and the receiver device outputs the remaining symbols which are not fixed at block 970 if any. The fixed symbols and the unfixed symbols form a set of final estimated symbols for further processing, for example, for channel decoding.

As can be observed from the example shown in FIG. 9, the SSF framework proposed in the present disclosure has at least the following features:

(i) It may provide a type of ML method, by fixing estimated symbols using a Euclidean distance based criterion, stage by stage, to remove inter-symbol interference.

(ii) It has a complexity same as that of the used MDA( ) function, because neither Fix( ) nor Update( ) function introduces much complexity and the required stages are normally far less than Nt.

(iii) It may be used in a network device, and also a terminal device if the MDA( ) function can be supported by the terminal device.

(iv) It may achieve better detection accuracy even if a detection algorithm with low detection accuracy and low complexity is used in MDA( ) function in each stage. That is, the proposed framework enables to build low complexity and high accuracy mMIMO detection algorithms. If the detection algorithm used in MDA( ) is already an optimal algorithm with high computing complexity, the staged processing may not achieve significant gains.

(v) It inherits the properties of the detection algorithm used in MDA( ) in each stage. For example, if a MDA( ) function supports hybrid modulation modes, the proposed SSF solution supports the hybrid modulation modes as well.

(vi) In each stage of the proposed staged detection frame work, a different MDA( ) function, i.e., a different detection algorithm, may be used.

(vii) The MDA( ) function in each stage outputs soft estimated symbols.

Among other advantages, some embodiments of the staged signal detection framework proposed in the present disclosure provide a more flexible signal detection solution. For example, the staged signal detection may be configured via one or more of the parameters shown in Table 7 below.

TABLE 7
Examples of configuration parameters

| Name | Description |
|---|---|
| Nₜₒₜ | the total number of stage. |
| fNum | used for example in Fix( ) to indicate number of symbols |
| | required to be fixed in a stage |
| fRatio | a value between 0 and 1, stands for a ratio of symbols to be |
| | fixed. |

In some embodiments, fRatio may be used for determining fNum and/or Nₜₒₜ. For example, fNum may be obtained using equation (16) or (17) based on fRatio, and Ntot may be obtained using (22) based on fRatio. If fRatio=½, equation (22) may be simplified to equation (23) below.

Nₜₒₜ=[log₂Nₜ]+1 (23)

It can be observed from equation (23) that the total number of stages for detection may be much less than the number of transmitting antennas, which means low complexity of the proposed scheme. This is advantageous, since a target for mMIMO detection is to fix as much symbols as possible to get an optimal detection accuracy and at the same time keep the computing complexity as low as possible.

Note that, the staged signal detection solutions proposed in the present disclosure do not require fixing all the detected symbols. In practice, if detection accuracy already meets a predefined requirement by fixing only a portion of the detected symbols, there is no need to fix all the detected symbols, and in such a case, the total number of stages may be reduced.

In some embodiments, the configuration parameters shown in Table 7 for the staged signal detection solution may be determined based on a receiving SNR. Normally, fRatio may take a value in a range of [0.5, 0.7], which allows fixing enough symbols in the first processing stage and at the same time avoids an increase in detection error probability.

Furthermore, as already described above, in some embodiments of the present disclosure, the detection algorithm used in a stage of the staged signal detection framework may be selected based on needs, and the selection may even be stage specific. Such a mechanism provides more flexibility to the proposed staged detection framework.

For illustration purpose, some examples for the detection algorithm may be described below, however, it should be appreciated that embodiments are not limited thereto.

In an example embodiment, a MMSE detection algorithm/detector is selected for each stage, and such a staged detection solution is also referred to as a ssfMMSE solution herein. MMSE is a popular low complexity detection algorithm, and a detected symbol output from a MMSE detector may be expressed as following equation (24):

\hat{x}=ρ(ρH^{H}H+I)⁻¹H^{H}y (24)

where ρ is related to SNR, and is obtained by ρ=10^{(SNR/10)}, I is an unit matrix with size (Nt, Nt), H stands for the channel matrix, and y stands for the received signals. In ssfMMSE, the \hat{x} output from the MMSE detector is used as an input to a following fixing operation/function to obtain one or more fixed detected symbols.

In another example embodiment, a ZF detection algorithm is selected for each stage, and such a staged detection solution is also referred to as a ssfZF solution herein. ZF is another very popular detection algorithm, and a detected symbol output from a ZF detector may be expressed as following equation (25):

\hat{x}=(H^{H}H)⁻¹H^{H}y (25)

where H stands for the channel matrix, and y stands for the received signals. In ssfZF, the \hat{x} output from the ZF detector is used an input to a following fixing operation/function to obtain one or more fixed detected symbols.

In still another example embodiment, a GD based detection algorithm, for example a SGD detection algorithm proposed in the present disclosure for MIMO detection, may be selected for each stage, and such a staged detection solution is also referred to as a ssfSGD solution herein.

The SGD detection algorithm transfers problem of equation (1) into an ANN problem, as illustrated schematically in FIG. 2. As shown in FIG. 2, with this ANN model, each row vector (hᵢ₁, hᵢ₂, . . . h_{iNt}) of the channel matrix H is considered as an input vector, the received value yᵢ associated with a corresponding row of H is considered as an output, while vector x=[x₁, x₂, . . . x_{Nt}] is modelled as weights to be learned.

The SGD detection method (which may also be referred to as SGD learning method) may be used to solve the ANN problem and converges quickly. In SGD learning method, a loss function for the ith row of H may be defined as:

Lossᵢ(x)=½|yᵢ−Σⱼhᵢⱼ*xⱼ|² (26)

A differential for xⱼ may be obtained by:

$$\frac{\partial Los {s}_{i}}{\partial {x}_{j}} = - ( {y}_{i} - {\sum }_{j} {h}_{ij} * {x}_{j} ) {h}_{i j}^{*} \qquad ( 27 )$$

The obtained differential is used as a gradient descent direction for updating xⱼ. For example, xⱼ may be updated by:

xⱼ=xⱼ+R*(yᵢ−Σⱼhᵢⱼ*xⱼ)h*ᵢⱼ (28)

where R stands for a learning rate, or called a learning step, which is used for controlling the update of the xⱼ. More details about the GD based mMIMO detection have been provided above in the present disclosure, and details will not be repeated.

In the ssfSGD solution, the xⱼ output from the SGD detector is used as an input to a following fixing operation/function to obtain one or more fixed detected symbols. Note that in the ssfSGD solution, a separate updating function as shown in block 960 of FIG. 9 may not be required, since the updating operation is already performed within the SGD detection algorithm, i.e., at block 910 of FIG. 9 when SGD detection algorithm is selected for signal detection in a stage.

One advantage of the ssfSGD solution is that it is easy to implement by reusing ANN implementations. For example, the fixing operation/function in the proposed ssfSGD solution may be implemented by using a dropout function in ANN. Originally, the dropout function in ANN is a regularization technique for reducing overfitting in neural networks by preventing complex co-adaptations on training data. Dropout refers to ignoring weights updating during the training phase, the dropout weights are selected randomly. In the ssfSGD solution, the dropout function shall be used in a different way. The dropout function in the ssfSGD solution is same as that in ANN in terms of ignoring weights (corresponding to detected symbols in the ssfSGD solution) updating during later learning phase, but differs in that weights (i.e., detected symbols in the ssfSGD solution) to be fixed are determined by a Fix( ) function, while in ANN, the weight to be fixed is determined randomly. Same as that in ANN, once the weights (symbols) are fixed, they shall be always fixed/unchanged in later stages (later learning phases), and shall not participate in later detection. Therefore, an ANN method with a new dropout function may be easily implemented in an ANN enabled hardware, to provide a ssfSGD solution. That is, the ssfSGD solution for MIMO signal detection may be implemented by reusing ANN hardware. This is a big benefit for ssfSGD usage.

To evaluate performance of the staged signal detection solution proposed herein, tests for UL mMIMO signal detection have been conducted via computer simulation. Settings of signals and parameters for the tests are summarized in Table 8 and Table 9.

TABLE 8
Signal generation for the test

| Parameters | Settings |
|---|---|
| H | element is generated by N(0, 1), then normalized by |
| | H = H/sqrt(Nt), N(0, 1) is normal distribution with |
| | a mean of 0 and a variance of 1 |
| z | generated by N(0, 1), then normalized by z = |
| | z/(10\hat{ }(SNR/10)) |
| x | normalized by x = x/var(x), where var(x) means the |
| | variance of symbol x |
| y | calculated by equation (1) |

TABLE 9
Uses cases for the test

| Cases | Configuration of parameters |
|---|---|
| Case 1 | Nr = 60, Nt = 30 |
| | Modulation: BPSK |
| | SNR = 8 dB to 13 dB, |
| | for each SNR, 20000 sampling points are generated for SER |
| | calculation; |
| | Nₜₒₜ = 5; |
| | fRatio = 0.5 |
| Case 2 | Nr = 64, Nt = 16 |
| | Modulation: 16QAM |
| | SNR = 8 dB to 13 dB, |
| | for each SNR, 20000 sampling datas are generated for SER |
| | calculation; |
| | Nₜₒₜ = 5, |
| | fRatio = 0.5 |

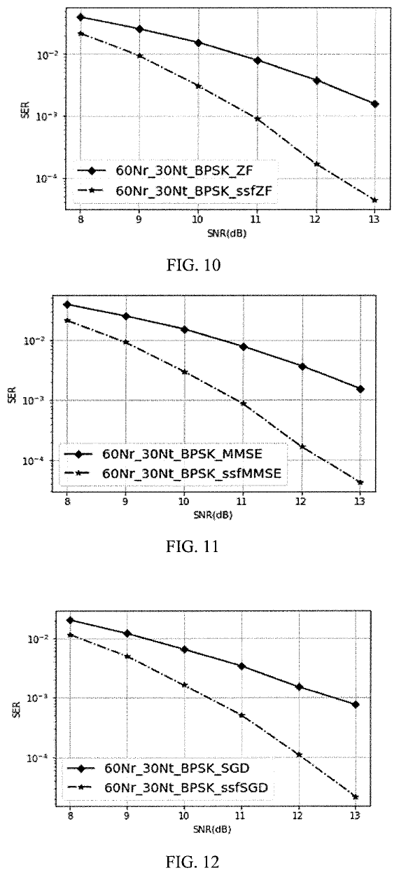

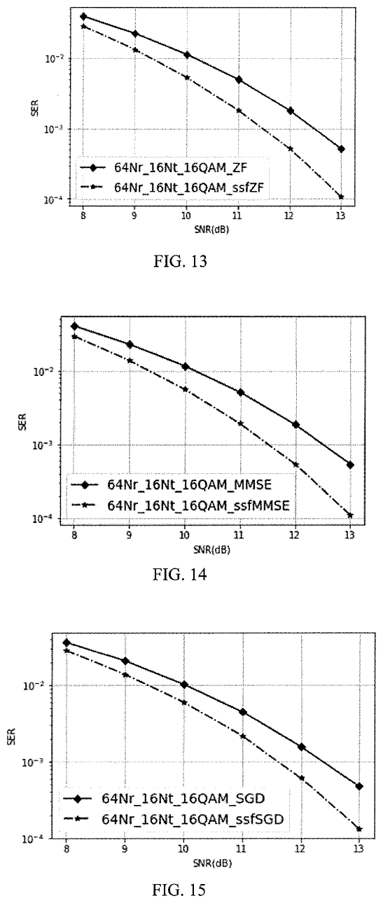

Computer simulation results for the two testing cases and three different staged detection algorithms, including ssfZF, ssfMMSE andssfSGD, are shown in FIGS. 10-15, from which improvement in detection accuracy brought by the staged signal detection solution proposed herein can be observed. For example, FIGS. 10-11 show that compared with a conventional ZF/MMSE detection algorithm, the staged ZF/MMSE detection solution (i.e., ssfZF/ssfMMSE) achieves lower symbol error rate (SER) at same SNR level for test case 1 where 60 receiving antennas, 30 transmitting antennas and BPSK modulation are used. Likewise, FIG. 12 shows that a staged SGD (i.e., ssfSGD) detection solution achieves better performance than a normal SGD detection solution. Results for test case 2 are shown in FIGS. 13-15, and from which it can be observed that performance gain from the staged detection solutions also exists in a MIMO system with 64 receiving antennas, 16 transmitting antennas and 16QAM modulation.

The staged signal detection solution proposed in the present disclosure for MIMO detection has some or all of the following advantage:
(a) Computing complexity of the staged signal detection solution is almost in the same level as that of the detection algorithm used in a stage, i.e., no obvious extra computing complexity is introduced due to a staged operation. Furthermore, the number of stages may be selected properly to achieve a tradeoff between complexity and accuracy.
(b) The staged signal detection solution may be used in a network device and also a terminal device, if the detection algorithm used in a stage is supported by the terminal device.
(c) It improves detection accuracy considerably.
(d) It provides a method to build a MIMO detection algorithm with low computing complexity and high detection accuracy.
(e) It inherits properties of the detection algorithm used in each stage, i.e., if the detection algorithm is a flexible algorithm (e.g., SGD), the staged solution is also a flexible algorithm.
(f) a SGD based staged detection solution is very suitable to be implemented by using a developed ANN, especially in ANN enabled HW.
(g) The proposed staged detection solution allows using different detection algorithm in different stages, which provides extra flexibility for the detection.

Though computer simulation for UL mMIMO signal detection is conducted, it should be appreciated that the staged signal detection solution proposed in the present disclosure also applies to DL mMIMO signal detection. For DL mMIMO signal detection, the terminal device, for example, the terminal device 102 in FIG. 1 acts as a receiver device. The terminal device 102 may need to detect signals from a single base station or a plurality of base stations depending on its operating mode. In some embodiments, the terminal device 102 may receive signals from the network device 101, and in such a case, both the number of receiving antennas and the number of transmitting antennas may be reduced compared with UL mMIMO signal detection. That is, same staged signal detection solution as described with reference to UL MIMO detection also applies, but computation complexity may be further reduced due to reduced number of antennas.

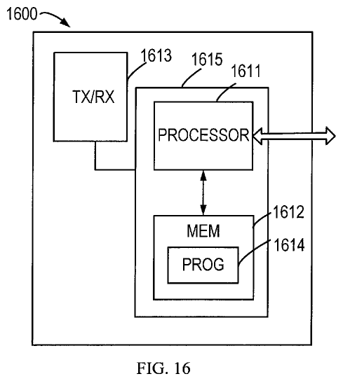

FIG. 16 illustrates a simplified block diagram of an apparatus 1600 that may be embodied as or comprised in a receiver device, for example, a terminal device 102 or a network device 101 shown in FIG. 1.

The apparatus 1600 comprises at least one processor 1611, such as a data processor (DP) and at least one memory (MEM) 1612 coupled to the processor 1611. The apparatus 1610 may further include a transmitter TX and receiver RX 1613 coupled to the processor 1611, which may be operable to communicatively connect to other apparatuses. The MEM 1612 stores a program or computer program code 1614. The at least one memory 1612 and the computer program code 1614 are configured to, with the at least one processor 1611, cause the apparatus 1600 at least to perform in accordance with embodiments of the present disclosure, for example method 600 or 900.

A combination of the at least one processor 1611 and the at least one MEM 1612 may form processing means 1615 configured to implement various embodiments of the present disclosure.

Various embodiments of the present disclosure may be implemented by computer program executable by the processor 1611, software, firmware, hardware or in a combination thereof.

The MEM 1612 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processor 1611 may be of any type suitable to the local technical environment, and may include one or more of general purpose computers, special purpose computers, microprocessors, digital signal processors (DSPs) and processors based on multicore processor architecture, as non-limiting examples.

Although some of the above descriptions on the GD based signal detection and staged signal detection are made in the context of a wireless communication system shown in FIG. 1, it should not be construed as limiting the spirit and scope of the present disclosure. The principle and concept of the present disclosure may be more generally applicable to other scenarios.

In addition, the present disclosure may also provide a carrier containing the computer program as mentioned above (e.g., computer instructions/grogram 530 in FIG. 5 or 1614 in FIG. 16). The carrier includes a computer readable storage medium and a transmission medium. The computer readable storage medium may include, for example, an optical compact disk or an electronic memory device like a RAM (random access memory), a ROM (read only memory), Flash memory, magnetic tape, CD-ROM, DVD, Blue-ray disc and the like. The transmission medium may include, for example, electrical, optical, radio, acoustical or other form of propagated signals, such as carrier waves, infrared signals, and the like.

The techniques described herein may be implemented by various means so that an apparatus implementing one or more functions of a corresponding apparatus described with an embodiment comprises not only prior art means, but also means for implementing the one or more functions of the corresponding apparatus and it may comprise separate means for each separate function, or means that may be configured to perform two or more functions. For example, these techniques may be implemented in hardware (e.g., circuit or a processor), firmware, software, or combinations thereof. For a firmware or software, implementation may be made through modules (e.g., procedures, functions, and so on) that perform the functions described herein.

Some example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, may be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments may also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept may be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

Some abbreviations used in the present disclosure and their corresponding expressions are list below:

GD: gradient descent
BGD: batch gradient descent
SGD: stochastic gradient descent
MIMO: multiple input multiple output antenna system
mMIMO: massive multiple input multiple output antenna system
SVD: singular value decomposition
5G: the fifth generation telecommunication system
gNodeB: 5G NodeB
AWGN: additive white gaussian noise
ZF: zero forcing
ZF-IC: zero forcing with interference cancellation
LMMSE: linear minimum mean square error
LMMSE-IC: linear minimum mean square error with interference cancellation
SSF: staged symbol fix
MDA: MIMO detection algorithm
ssfMDA: staged symbol fix based MIMO detection algorithm
AMP: approximate message passing
PDA: probabilistic data association

### MCMC: Markov Chain Monte Carlo

SDR: semidefinite relaxation

### QAM: Quadrature Amplitude Modulation

### BPSK: Binary Phase Shift Keying

### QPSK: Quadrature Phase Shift Keying

ANN: artificial neuron network
DNN: deep neuron network
SER: symbol error ratio
SNR: signal noise ratio

References obtained from the following links are attached:
http://ieeexplore.ieee.org/document/7282651/;
https://emtiyaz.github.io/Writings/approxMP0.pdf; and
https://arxiv.org/abs/1706.01151.

1. A method for staged signal detection, comprising:
obtaining a set of received signals;
determining a channel matrix via which the set of received signals have been transported; and
detecting the set of received signals in a staged manner,
wherein in a stage, the method comprises:
detecting the set of received signals, based on the channel matrix and a detection algorithm for the stage;
fixing one or more of detected symbols output from the detecting algorithm for the stage; and
updating the channel matrix and the set of received signals for usage by a next stage, based on the one or more of the detected symbols that are fixed in the stage.

2. The method of claim 1, wherein the one or more of the detected symbols are determined based on a number that is configurable, and
further comprising:
determining a ratio of symbols to be fixed in a stage; and
determining the total number of stages for detecting and the number of symbols to be fixed in the stage, based on the determined ratio of symbols to be fixed.

3. (canceled)

4. The method of claim 2, wherein determining the ratio of symbols to be fixed in a stage comprises:
determining the ratio of symbols to be fixed in the stage based on a receiving signal to noise ratio, SNR.

5. The method of claim 2, wherein the total number of stages is determined by:
Nₜₒₜ=[−log_{(1-fRatio)}Nₜ]+1
where Ntot denotes the total number of stages, fRatio denotes the ratio of symbols to be fixed in a stage, and Nₜ denotes the number of transmitting antennas.

6. The method of claim 2, wherein the number of symbols to be fixed in a stage is determined by:
fNum=[len(ds)*fRatio], or
fNum=max(1,[len(ds)*fRatio]);
where fNum denotes the number of symbols to be fixed in the stage, len(ds) denotes the total number of input symbols for the stage, fRatio denotes the ratio of symbols to be fixed in the stage, and [.] denotes an operation of getting an integer part of a real number.

7. The method of claim 1, wherein fixing one or more of the detected symbols comprises:
selecting, for each detected symbol output from the detection algorithm, a candidate symbol from a set of modulation constellation symbols determined by a modulation scheme for the set of received signals, based on a maximum likelihood criterion,
determining a distance between each detected symbol and a corresponding candidate symbol; and
fixing the one or more of the detected symbols associated with the minimum distance to a corresponding candidate symbol respectively.

8. The method of claim 1, wherein the detection algorithm for a stage includes one of:
a Zero forcing, ZF, based algorithm,
a Minimum Mean Square Error, MMSE based algorithm, or
a gradient descent, GD, based algorithm.

9. (canceled)

10. The method of claim 1, wherein updating the channel matrix and the set of received signals comprises:
removing, from the channel matrix, one or more columns corresponding to the one or more of the detected symbols that are fixed in a current stage; and
subtracting, from the set of received signals, a value contributed by the one or more of the detected symbols that are fixed in the current stage.

11. (canceled)

12. The method of claim 1, further comprises:
outputting the one or more of the detected symbols that are fixed in each stage, and
if there is a remaining symbol unfixed after completion of the staged signal detection, outputting the remaining symbol.

13. (canceled)

14. A receiver device, comprising:
at least one processor; and
at least one non-transitory memory including computer program code;
the at least one memory and the computer program code are configured to, with the at least one processor, cause the receiver device at least to:
obtain a set of received signals;
determine a channel matrix via which the set of received signals are transported;
detect the set of received signals in a staged manner, and
in a stage, cause:
detecting the set of received signals, based on the channel matrix and a detection algorithm for the stage;
fixing one or more of detected symbols output from the detecting algorithm for the stage; and
updating the channel matrix and the set of received signals for usage by a next stage, based on the one or more of the detected symbols that are fixed in the stage.

15. The receiver device of claim 14, wherein the one or more of the detected symbols are determined based on a number that is configurable,
wherein the at least one memory and the computer program code are configured to, with the at least one processor, further cause said receiver device to:
determine a ratio of symbols to be fixed in a stage; and
determine the total number of stages and the number of symbols to be fixed in a stage based on the determined ratio of symbols to be fixed.

16. (canceled)

17. The receiver device of claim 15, wherein said receiver device is further caused to determine the ratio of symbols to be fixed in a stage based on a receiving signal to noise ratio, SNR.

18. The receiver device of claim 15, wherein the total number of stages for detecting is determined by:
Nₜₒₜ=[−log_{(1-fRatio)}Nₜ]+1
where Nₜₒₜ denotes the total number of stages, fRatio denotes the ratio of symbols to be fixed in a stage, and Nₜ denotes the number of transmitting antennas.

19. The receiver device of claim 15, wherein the number of symbols to be fixed in a stage is determined by:
fNum=[len(ds)*fRatio], or
fNum=max(1,[len(ds)*fRatio]);
where fNum denotes the number of symbols to be fixed in the stage, len(ds) denotes the total number of input symbols for the stage, fRatio denotes the ratio of symbols to be fixed in the stage, and [.] denotes an operation of getting an integer part of a real number.

20. The receiver device of claim 14, wherein the receiver device is further caused to fix one or more of the detected symbols by: selecting, for each detected symbol output from the detection algorithm, a candidate symbol from a set of modulation constellation symbols determined by a modulation scheme for the set of received signals, based on a maximum likelihood criterion, determining a distance between each detected symbol and a corresponding candidate symbol; and fixing the one or more of the detected symbols associated with the minimum distance to a corresponding candidate symbol respectively.

21. The receiver device of claim 14, wherein the detection algorithm for a stage includes one of:
a Zero forcing, ZF, based algorithm,
a Minimum Mean Square Error, MMSE based algorithm, or
a gradient descent, GD, based algorithm.

22. (canceled)

23. The receiver device of claim 14, wherein the at least one memory and the computer program code are configured to, with the at least one processor, further cause said receiver device to update the channel matrix and the set of received signals by:
removing, from the channel matrix, one or more columns corresponding to the one or more of the detected symbols that are fixed in a current stage; and
subtracting, from the set of received signals, a value contributed by the one or more of the detected symbols that are fixed in the current stage.

24. (canceled)

25. The receiver device of claim 14, wherein the at least one memory and the computer program code are configured to, with the at least one processor, further cause said receiver device to:
output the one or more of the detected symbols that are fixed in each stage, and
if there is a remaining symbol unfixed after completion of the staged signal detection, output the remaining symbol.

26. (canceled)

27. A receiver device, comprising:
circuitry configured to obtain a set of received signals;
circuitry configured to determine a channel matrix via which the set of received signals have been transported; and
circuitry configured to detect the set of received signals in a staged manner,
wherein in a stage, the circuitry configured to detect is configured to cause:
detecting the set of received signals, based on the channel matrix and a detection algorithm for the stage;
fixing one or more of detected symbols output from the detecting algorithm for the stage; and
updating the channel matrix and the set of received signals for usage by a next stage, based on the one or more of the detected symbols that are fixed in the stage.

28. A computer readable medium having a computer program stored thereon which, when executed by at least one processor of a device, causes the device to carry out the method of claim 1.
